(19) United States
(12) Patent Application Publication
(10) Pub. No.: US 2026/0050814 A1
(43) Pub. Date: Feb. 19, 2026

(54) HYBRID QUANTUM-CLASSICAL METHOD FOR AUTOMATED LABELING AND VALIDATION

(71) Applicant: JITESH HARI LALWANI, PUNE (IN)

(72) Inventor: JITESH HARI LALWANI, PUNE (IN)

(21) Appl. No.: 19/291,668

(22) Filed: Aug. 6, 2025

Related U.S. Application Data
(60) Provisional application No. 63/682,719, filed on Aug. 13, 2024.

(51) Int. Cl. G06N 10/60

(52) U.S. Cl. CPC G06N 10/60

(57) ABSTRACT

This invention introduces a method and system for auto-labeling data through a hybrid Quantum-Classical approach. Initially, data is acquired, converted to a usable format, and reference data points for target objects are extracted and data is smoothened, reduce its dimensionality via Principal Component Analysis. The quantum machine learning (QML) component is then applied to validate the data, leveraging quantum algorithms for enhanced accuracy and efficiency. Grouping of similar data points occur utilizing statistical techniques, with a threshold ensuring only highly similar data points are selected from one target reference data point as input along with target area. The validated data is auto-labeled using QML, significantly enhancing the efficiency and accuracy of data analysis. Embodiments of this method are particularly beneficial for remote sensing applications such as environmental monitoring, agricultural assessment, urban planning and defense uses, providing precise classification of land cover and materials.

### BACKGROUND

This invention relates to the field of statistical techniques and Quantum Machine Learning (QML), focusing on the accurate auto-labeling of data using a hybrid Quantum-Classical approach. The method enhances data analysis efficiency and accuracy, leveraging Quantum Machine Learning (QML) for superior classification performance.

This invention addresses the challenge of auto-labeling previously unlabeled data, particularly when labels distinguishing different types of macro and micro data are absent. To solve this, a hybrid Quantum-Classical solution is proposed. Classical methods are utilized for reference data extraction, data smoothening, dimensionality reduction, and the auto-labeling of objects. Quantum Machine Learning (QML) is then employed specifically for validating label accuracy, enhancing the classification of similar or overlapping spectral signatures. The integration of QML in this process significantly improves accuracy and efficiency compared to traditional Machine Learning (ML) techniques.

The classical processes are executed on a classical computer, where the data is auto-labeled. This auto-labeled data then serves as the input for the Quantum Machine Learning (QML) algorithm, which is responsible for validating the accuracy of the labels. Up to the auto-labeling step, all computations are handled by classical computers. Once this step is complete, a quantum computer or a quantum computing simulator is employed to carry out the validation process, leveraging the strengths of quantum computing for superior accuracy and efficiency. The usage of a Quantum Computer for validation is carried out by accessing them through the cloud or on premise from a classical computer, in case of usage of a Quantum Computing simulator for the validation, it is carried out on the classical computer itself.

Macro-level data in remote sensing includes information on land use, vegetation cover, and large water bodies. It focuses on the general characteristics and patterns over a wide area, often used for monitoring environmental changes, urban development, or agricultural practices. Micro-level data include information on individual plants, small water bodies, or specific man-made structures. It involves high-resolution data that can detect fine details, making it useful for tasks such as species identification, precision agriculture, or detailed environmental assessments.

The process begins by obtaining the data of the target area from reference dataset. The data files are then acquired from the respective website, containing detailed data. These files are converted to usable file format for further processing. A specific part of the area is extracted from the usable file to identify reference data points associated. The data is smoothened using a Median Filter to reduce noise. Principal Component Analysis (PCA) is then applied to condense the original data to significant feature vectors for each data point.

The reduced data set is divided into training and testing points. The QML model is refined until a classification score of 0.95 or higher is achieved. A target reference data point is selected for generating validation samples. All data points in the chosen area are smoothened and subjected to PCA to obtain feature vectors. Feature vectors are numerical representations that capture the essential characteristics of data points after dimensionality reduction, such as through PCA. They contain the most significant information from the original dataset, summarized in a compact form. These vectors, along with the reference data point, are inputted into the statistical measure called Kullback-Liebler divergence (KLD) to group similar data points. A threshold is set for KLD to ensure only highly similar data points are selected for validation.

The filtered data is then validated using QML, achieving accurate auto-labeling of the data. This hybrid solution improves the efficiency and accuracy of data analysis, reducing the need for extensive training data. The method is particularly useful for remote sensing applications such as environmental monitoring, agricultural assessment, and urban planning, where precise classification of land cover and materials is essential.

This invention provides a robust and advanced method for data classification, combining state-of-the-art quantum and classical computing techniques to deliver superior results in data analysis.

The summary of the invention provides a basic understanding of some aspects of the invention. This summary is not intended to identify all key or critical elements of the invention or to delineate the entire scope of the invention. Its sole purpose is to present some concepts of the invention in a simplified form as a prelude to the more detailed description that is presented later.

Reference throughout this specification to “one embodiment” or “an embodiment” means that a particular feature, structure, or characteristic described in connection with an embodiment is included in at least one embodiment of claimed subject matter. Thus, appearances of phrases such as “in one embodiment” or “an embodiment” in various places throughout this specification are not necessarily all referring to the same embodiment. Furthermore, particular features, structures, or characteristics may be combined in one or more embodiments.

Additional features and advantages of the invention will be set forth in the detailed description which follows, which, taken in conjunction with the accompanying drawings, by way of example, together illustrate the features of the present invention, which will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF DRAWINGS

The process begins by retrieving the data of target object from reference dataset. The data is then acquired from the respective platforms. This file includes the selected map area. A portion of the whole area is then extracted from the file to obtain the target reference data. The acquired data is smoothened using a Median Filter.

Principal Component Analysis (PCA) is applied to the target data point, reducing it to highly contributing feature vectors. These vectors are used to train and test the QML algorithm. If the classification score exceeds 0.95, then it is deemed ready for validation. If not, additional data of the target object are retrieved from the reference dataset, and the process is repeated. One target reference data point is taken to generate samples required for validation, and all data points in the chosen area are filtered and subjected to PCA to obtain the highly contributing feature vectors of each data point.

FIG. 1 illustrates an end-to-end workflow 100 that begins with raw data 100 (e.g., hyperspectral image cubes or other multichannel sensor products) and culminates in a validated, auto-labeled dataset 104 suitable for downstream analytics. In a first stage 101 the raw data are cleansed, formatted, and randomly partitioned into training and testing subsets as further detailed in FIG. 2. Decision block 102 evaluates a classification score generated by a quantum machine-learning (QML) model; if the score does not exceed a predefined threshold (≥0.95 in the present embodiment) control loops back to block 101 for additional preprocessing or augmentation. Once the threshold is satisfied, block 103 invokes an auto-labeling module that applies the trained QML classifier to unlabeled pixels/voxels, and block 104 re-validates the newly generated labels using the same QML architecture to ensure internal consistency.

FIG. 2 expands the preprocessing layer 200. Module 200 converts proprietary or scientific file formats (for example, HDF-EOS5 hyperspectral granules) into an analysis-ready, lossless container such as GeoTIFF. Block 201 crops a geographic window corresponding to the target area supplied by the operator, thereby reducing the computational footprint. A separate reference dataset 202—typically a library of previously identified spectra—is simultaneously ingested. Block 203 extracts one or more target reference data points that will act as anchors for supervised learning and later statistical similarity tests. Each pixel vector is passed through a median filter 204 to suppress impulsive noise and sensor artifacts. Principal-component analysis (PCA) 205 then projects the 239-band spectrum (in the illustrative hyperspectral case) onto a lower-dimensional sub-space (sixteen components in the present experiments), generating a compact, information-rich training dataset 206.

FIG. 3 depicts an auto-labeling sub-pipeline 300 used after a stable QML model is obtained. Starting from the reference dataset 300, block 301 selects a single target reference spectrum and synthesizes an initial validation set. The spectra are again median-filtered in block 302 and dimensionality-reduced by PCA in block 303 so that the statistical grouping stage 304 operates on homogeneous feature vectors. Statistical similarity is quantified with the Kullback-Leibler divergence (KLD) measure; only spectra whose KLD with respect to the reference point falls below a user-specified threshold ε are admitted to the validation pool.

FIG. 4 depicts the superposition of a quantum bit of information called qubit.

FIG. 5 depicts the entanglement of a qubit.

FIG. 6 depicts the Venn diagram of the QML arising from the intersection of Quantum computing and Machine Learning.

FIG. 7 presents the data-to-kernel pipeline 700 that prepares inputs for a quantum support-vector machine (QSVM). Dataset-preparation stage 700 converts the PCA matrix into fixed-precision floating-point numbers. Qubit-preparation block 701 allocates n qubits, where n equals the number of retained principal components (sixteen in the working example). Encoding stage 702 embeds each classical vector into a ZFeatureMap parameterised circuit whose rotation angles are proportional to the vector elements. The resulting multi-qubit state resides in an exponentially large quantum Hilbert space 703. Inner-product measurements between pairs of such states produce the QSVM kernel matrix 704, which is subsequently supplied to a quantum-enhanced SVM solver that runs either on cloud-based superconducting hardware or on a classical simulator.

FIG. 8 Depicts the Functions of a Quantum Circuit.

FIG. 9 details a classical pipeline 900 that may operate when quantum resources are offline. Blocks 900 through 904 implement data collection, preprocessing, feature extraction, vector transformation, and dataset generation using purely classical arithmetic; these stages mirror their quantum counterparts to guarantee interface compatibility.

FIG. 10 depicts the graphs of RGB, Multispectral and Hyperspectral imaging.

FIG. 11 depicts the Hyperspectral Reflectance data of a Pixel.

FIG. 12 depicts the normalized data plot and its smoothened version after applying the median filter on

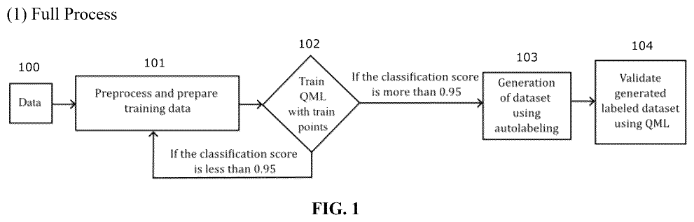

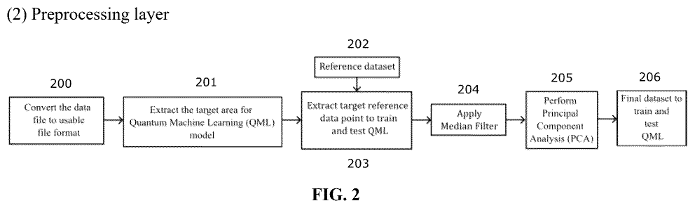

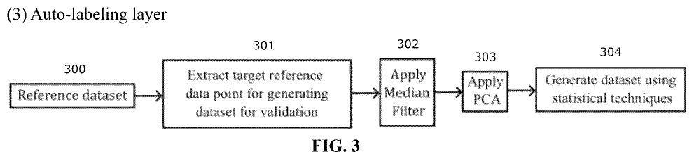

FIG. 11 Hyperspectral Reflectance data of a Pixel.

FIG. 13 depicts the concept of Principal Component Analysis (PCA).

FIG. 14 depicts the dimensionality reduced PCA plot of the data after applying filter.

FIG. 15 depicts the classification of a QSVM.

FIG. 16 depicts the Maximum Likelihood Estimation (MLE) used for data analysis.

FIG. 17 depicts the Quantum Circuit involved for data validation.

FIG. 18 depicts the input map and the resultant auto-labelled map.

The statistical techniques are then used to find and group similar data points based on the reference data point and the overall data of the target area. A threshold limit is set to these statistical techniques output, allowing only similar data above the limit for validation. The data obtained from the previous steps is fed into the trained QML algorithm, which has a classification score of 0.95 or above, to perform validation. This final step results in the auto-labeling of the unlabeled data.

### DETAILED DESCRIPTION OF PREFERRED EMBODIMENTS

The present invention is a method, system, and computer-implemented process, embodied on non- transitory computer-readable media, for efficiently auto-labeling unlabelled data using a hybrid Quantum-Classical approach. In particular, the invention addresses the challenge of classifying and validating data points in high-dimensional datasets, such as hyperspectral images, by integrating statistical preprocessing methods with quantum computing algorithms. The disclosed system reduces noise using a Median Filter, applies Principal Component Analysis to lower dimensionality, and leverages Quantum Machine Learning (QML) techniques for final classification and validation. This synergy of classical and quantum steps yields improved accuracy and speed relative to purely classical solutions, making it suitable for remote sensing, environmental monitoring, agricultural assessment, and similar applications requiring precise identification of target objects within extensive datasets.

The following detailed description is of the best currently contemplated modes of carrying out exemplary embodiments of the invention. The description is not to be taken in a limiting sense but is made merely for the purpose of illustrating the general principles of the present invention.

This invention addresses the challenge of processing data to auto-label unlabeled data with high accuracy by leveraging both classical and quantum computing techniques.

Quantum computing is a field of computing that leverages the principles of quantum mechanics to perform computations in ways fundamentally different from classical computing. Classical computers use bits as the smallest unit of data, which can exist in one of two states: 0 or 1.

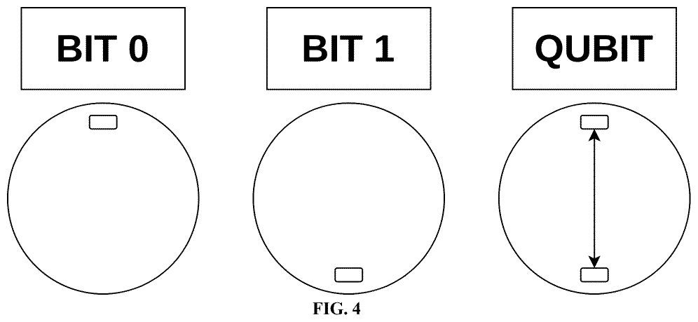

FIG. 4 Depicts the fundamental unit of information in quantum computing, analogous to a bit in classical computing. Unlike a classical bit, which can only be either 0 or 1, a qubit can exist in a superposition of both states at the same time. The concept of superposition is a cornerstone of quantum computing. In superposition, a qubit can represent both 0 and 1 at the same time, rather than being limited to one state or the other as in classical bits. This property enables quantum computers to explore multiple potential solutions to a problem simultaneously, providing a significant computational advantage in certain applications.

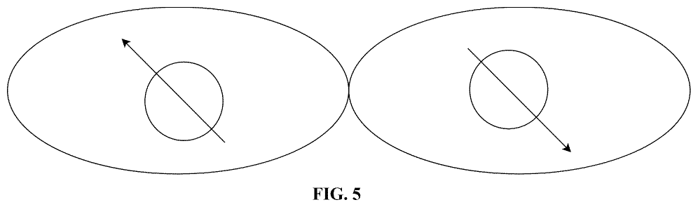

FIG. 5 depicts another concept in quantum computing which is entanglement, a quantum phenomenon where qubits become interconnected in such a way that the state of one qubit instantaneously influences the state of another, regardless of the distance between them. This entangled state is a powerful resource in quantum computing, enabling complex operations and communications that are impossible in classical systems.

Quantum gates are the quantum analogues of classical logic gates and are used to manipulate qubits. They perform operations on qubits, such as changing their state or entangling them with other qubits. Classical gates, which operate on bits in a deterministic way, quantum gates operate on qubits probabilistically, reflecting the inherent uncertainties in quantum mechanics. These gates are the building blocks of quantum circuits, which are used to implement quantum algorithms—sets of instructions designed to solve specific problems using quantum computing. Quantum computing holds the potential to revolutionize fields by offering solutions to problems that are currently intractable for classical computers.

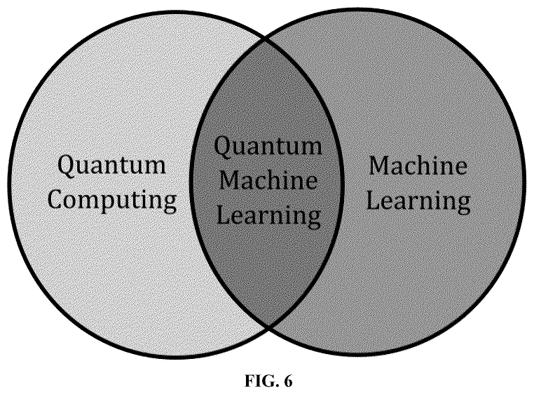

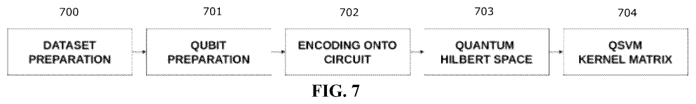

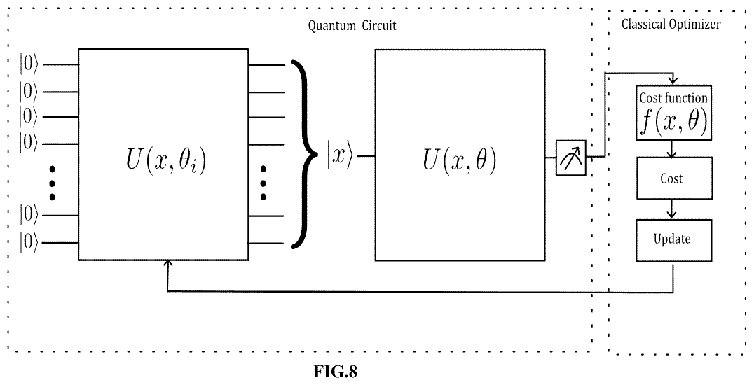

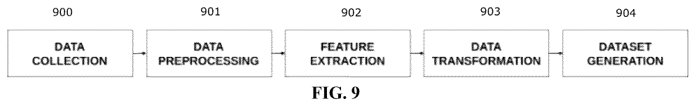

FIG. 6 explains about Quantum Machine Learning (QML) as an interdisciplinary field that combines principles of quantum computing with traditional machine learning techniques. It aims to leverage the unique properties of quantum computers, such as superposition and entanglement, to enhance the capabilities of machine learning algorithms. QML explores how quantum algorithms can be used to process and analyze data more efficiently, potentially offering exponential speedups for certain computational tasks compared to classical methods.

One of the key advantages of quantum computing in machine learning is its ability to handle vast amounts of data simultaneously. In classical machine learning, data is processed sequentially or in parallel to some extent, but quantum computers can process data in a fundamentally different way. By representing data as quantum states, QML algorithms can perform operations on multiple data points at once, enabling the exploration of a much larger solution space. This capability is particularly valuable in optimization problems, pattern recognition, and other areas where traditional algorithms struggle with large datasets.

Entanglement allows quantum systems to represent and process correlated data in ways that are not possible with classical systems. This property can be harnessed to develop new types of neural networks, clustering algorithms, and other machine learning models that may offer advantages in terms of accuracy and efficiency.

QML is used to validate data by enhancing the efficiency and accuracy and facilitating advanced applications in data analysis.

In a Quantum Machine Learning (QML) process, quantum computing principles are integrated with machine learning algorithms to harness the unique advantages of quantum mechanics, such as superposition and entanglement. This process involves several key steps, often mirroring the traditional machine learning workflow but with the addition of quantum-specific elements.

First, data preparation is crucial in QML. Data must be encoded into a quantum-compatible format, typically involving quantum states or qubits. This encoding process, known as feature mapping or data embedding, is essential for representing classical data in a quantum system. Different techniques, like amplitude encoding or basis encoding, are used depending on the problem and the nature of the data. The choice of encoding can significantly impact the efficiency and effectiveness of the quantum algorithm.

FIG. 7 depicts the flowchart presented outlines the essential steps in data preparation and structuring, which culminates in generating a dataset ready for input into a Quantum Machine Learning (QML) architecture. The process begins with data collection, where relevant data is gathered from various sources. This data then undergoes preprocessing, which includes cleaning, normalization, and handling of missing values to ensure consistency and quality. Following preprocessing, feature extraction is performed to identify and select the most relevant features that will contribute to the model's predictive power. The extracted features are then subjected to data transformation, where they are reformatted and structured to meet the specific requirements of quantum computation, making it possible for the data to be encoded onto qubits. Finally, the transformed data is compiled into a dataset, which is then fed into the QML architecture for further processing, training, and analysis, ultimately enabling the application of quantum computing techniques to solve complex problems.

FIG. 8 illustrates a quantum algorithm where the initial step involves preparing qubits in the (|00000. . . >) state. The first quantum circuit box encodes real-world data into these qubits, resulting in a quantum state denoted as (|x>). This state is then processed through a subsequent quantum circuit, which ultimately measures the qubits to calculate expectation values based on parametrized variables, θ. By varying these θ values, different expectation values are obtained, which contribute to the formation of a cost function. The cost function is then used to iteratively update the θᵢ parameters, repeating this optimization process until the desired quantum state or solution is achieved.

Once the data is encoded, the next step involves designing and applying a quantum algorithm to process the data. Quantum circuits, consisting of a series of quantum gates, are constructed to manipulate the quantum states. These gates perform operations that transform the input data into a form from which meaningful patterns or solutions can be extracted. These algorithms leverage quantum parallelism to explore multiple possibilities simultaneously, potentially offering exponential speed-ups over classical counterparts for specific tasks.

Following the application of quantum algorithms, measurement is performed to extract information from the quantum states. Measurement collapses the quantum states into classical bits, providing output data that can be analyzed.

FIG. 9 illustrates the process of Quantum Machine Learning (QML), by utilizing Quantum Support Vector Machine (QSVM) with a kernel matrix for result generation. A kernel matrix is used to measure how similar different data points are after being transformed by a quantum computer. Each entry in the matrix shows the similarity between two data points, which is calculated using quantum states. This matrix helps in tasks like classification and validation, where understanding the relationships between data points is important for making accurate predictions. Initially, raw data undergoes dataset preparation, which involves preprocessing and structuring the data for quantum processing which is explained in [0028].

Following this, qubit preparation is undertaken, where the number of qubits is determined based on the dimensionality of the data, ensuring that sufficient quantum resources are allocated for accurate analysis. The dimensionality of the data refers to the number of feature vectors or variables that describe each data point. When determining the number of qubits needed for quantum processing, we consider the reduced dimensionality of the data after applying techniques like Principal Component Analysis (PCA). PCA reduces the high-dimensional data to a smaller set of significant feature vectors, which capture the essential information. The number of these feature vectors corresponds to the number of qubits required for encoding the data onto a quantum circuit. For instance, if PCA reduces the data to five key feature vectors, five qubits would be needed to encode and process this data in the quantum system for further analysis and validation.

The data is then encoded onto a quantum circuit, which maps the classical information into quantum states, enabling it to be processed within the quantum Hilbert space. In this space, the data undergoes quantum operations that exploit the computational advantages of quantum mechanics. Quantum Hilbert space is a mathematical framework used to describe the state of quantum systems. It is an abstract, high-dimensional space where each point represents a possible quantum state of the system. In this space, quantum states are represented as vectors, and quantum operations, such as measurements and transformations, are represented as linear operators. The Hilbert space allows for the superposition and entanglement of quantum states, which are key features of quantum computing. Essentially, it's the environment in which quantum computations and quantum mechanics are mathematically modeled and analyzed.

Finally, the QSVM kernel matrix is applied, leveraging the power of quantum computing to perform machine learning tasks such as classification or regression, resulting in highly efficient and potentially more accurate outcomes compared to classical approaches. A quantum kernel matrix in the context of Quantum Support Vector Machines (QSVM) is a mathematical tool used to measure the similarity between data points. When data is mapped into this hilbert space using quantum computing, the kernel matrix captures the inner products between pairs of quantum states that represent the data. This matrix is crucial for performing tasks like classification or regression within QSVM, as it helps to identify patterns and relationships in the data that may not be easily detectable by classical methods, potentially leading to more efficient and accurate outcomes.

The process commences with raw data. This data undergoes a transformation through a Quantum Encoding Circuit, which maps the classical data into a quantum state. The resulting quantum state resides within a Quantum Hilbert Space, a complex vector space that serves as the computational arena for quantum algorithms. Subsequently, the quantum circuit operates on this state within the Hilbert space. Finally, the processed quantum data is fed into a QSVM with a kernel matrix, generating the desired output.

The classical processes are performed on a classical computer, where the data undergoes auto-labeling. This labeled data is then passed to the Quantum Machine Learning (QML) algorithm, which validates the label accuracy. Until the auto-labeling step, all tasks are managed by classical computers. Afterward, a quantum computer or quantum computing simulator is used for validation, capitalizing on quantum computing's enhanced accuracy and efficiency. When a quantum computer is used for validation, it is accessed either through the cloud or on-premises from a classical computer. If a quantum computing simulator is employed, the validation occurs directly on the classical computer.

The process begins by retrieving the data of target object, from the reference dataset for subsequent processing. To facilitate further processing, the data files are converted into desired usable format. From the converted file format, a specific part of the area is extracted to identify and extract reference data points associated with target area.

Data are obtained from various sources, including satellite and aerial imaging for environmental monitoring and agriculture, microscopic imaging for medical and biological research, and industrial inspection for quality control. It is also obtained from astronomy to analyze celestial objects, oceanography for monitoring water quality, and in the food and agriculture industries to assess crop health and food safety. Data is captured using specialized electronics such as satellites, drones, aircraft, and microscopic imaging systems.

For example, in one embodiment, HE5 files which contain hyperspectral data of 239 bands are converted to usable TIFF file format. The latitude and longitude of the target object is given as input from which the target object data is retrieved.

Hyperspectral imaging is an imaging technique that captures a wide spectrum of light across many narrow wavelength bands, ranging from ultraviolet to near-infrared. Unlike traditional RGB (red, green, blue) imaging, which only captures three broad bands of color corresponding to the visible spectrum, hyperspectral imaging provides detailed spectral information for each pixel in an image. This allows for the identification and analysis of materials based on their spectral signatures, which are unique to different substances.

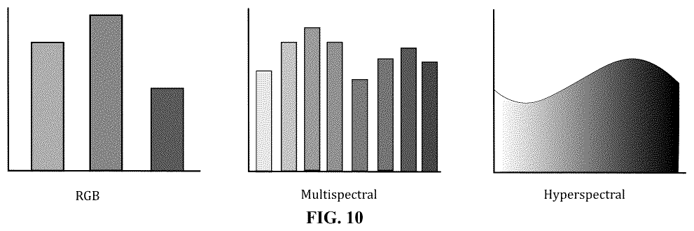

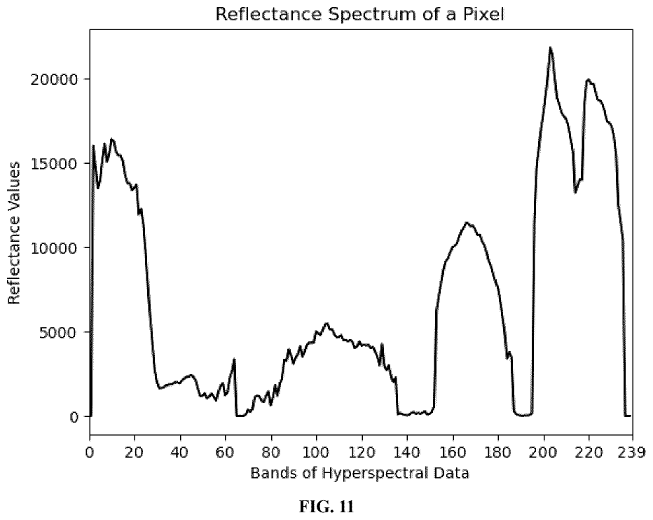

FIG. 10 depicts that hyperspectral imaging has a significant advantage over RGB and Multispectral imaging in its ability to identify and differentiate materials that appear similar in the visible spectrum but possess unique spectral features. Each pixel in a hyperspectral image contains a continuous spectrum, effectively creating a “spectral fingerprint” for the materials present, allowing for more precise and accurate identification and classification of objects, materials, and substances. In contrast, RGB imaging, while useful for general purposes and sufficient for many everyday applications, lacks the depth and specificity of hyperspectral imaging. In the same way, though Multispectral imaging gives images of different wavelengths, it does not convey the full picture as Hyperspectral imaging does.

Limited to three color channels and wavelengths, RGB and Multispectral images provide only a broad overview of the scene's color composition and spectral signature, leading to ambiguities or a lack of detail in material analysis. Different substances may reflect similar levels of red, green, and blue light, making them appear identical in an RGB image and only part of the information is only conveyed about the target objects spectral signature using Multispectral imaging, whereas they have distinct spectral signatures in a hyperspectral image, enabling more accurate classification. Overall, hyperspectral imaging offers a more detailed and comprehensive approach to material identification and classification, surpassing the capabilities of traditional RGB and Multispectral imaging by capturing the full spectral information of each pixel.

FIG. 11 provides a clear illustration of the reflectance spectrum for a specific pixel from a hyperspectral image. The x-axis indicates the different bands of hyperspectral data, spanning from 1 to 239, while the y-axis displays the associated reflectance values. The spectrum reveals noticeable peaks and troughs, reflecting the varying reflectance characteristics across different wavelengths.

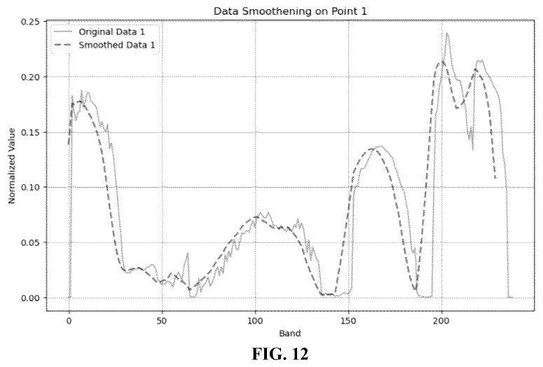

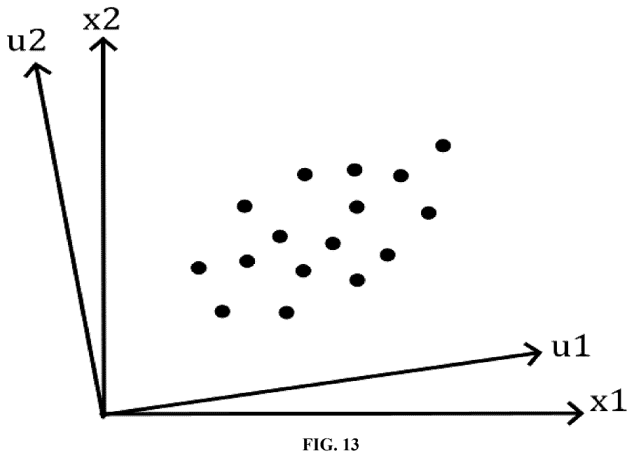

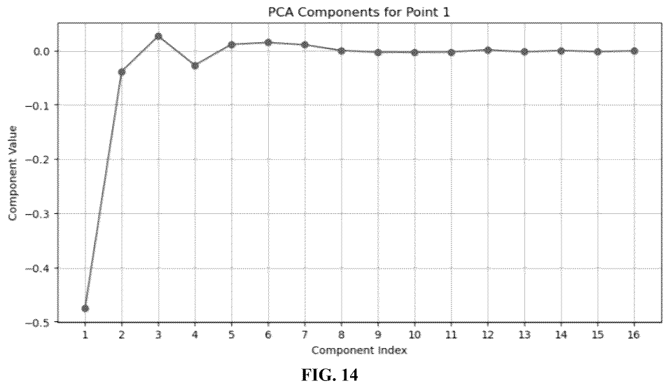

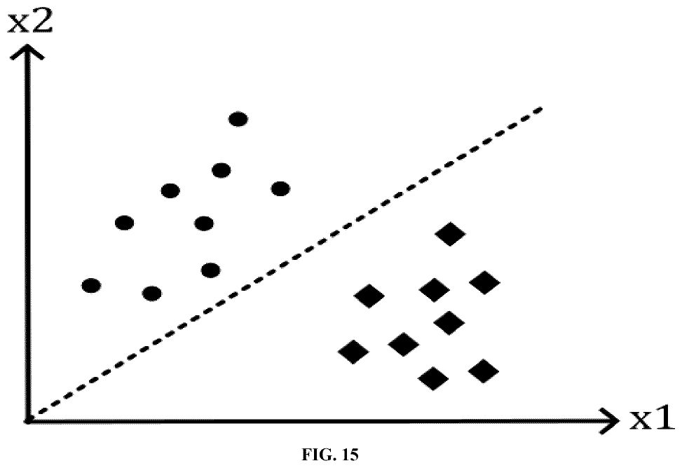

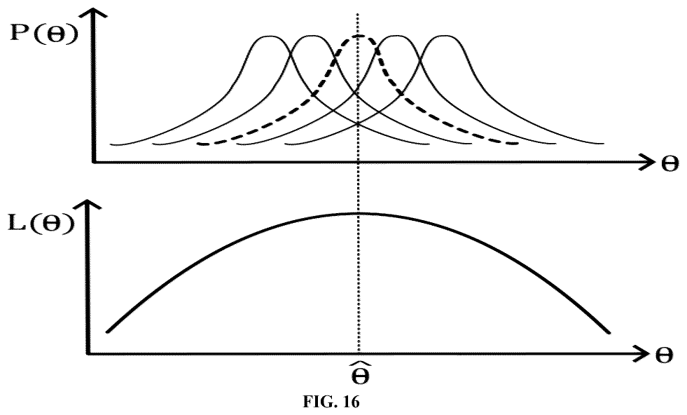

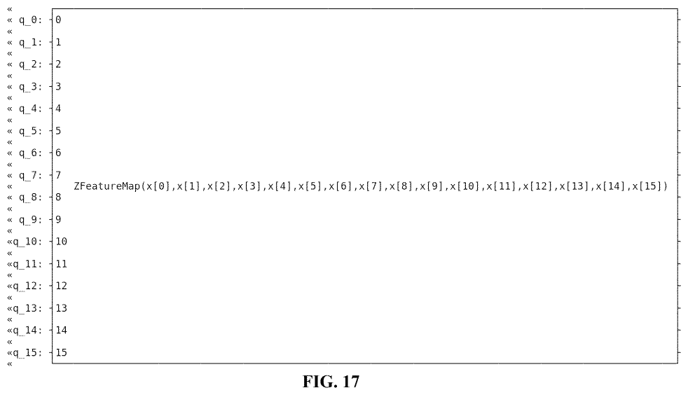

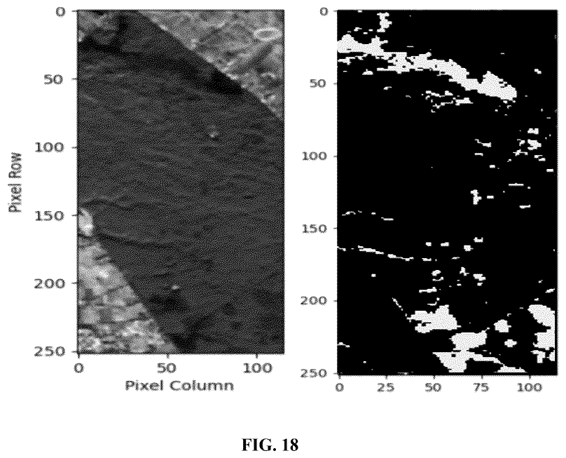

FIG. 12 depicts that acquired hyperspectral data of a pixel which is normalized and smoothened using a Median Filter. This step reduces noise and prepares the data for more accurate analysis. Principal Component Analysis (PCA) is then applied to the data point set to reduce its dimensionality. This standardized data set is crucial for accurate classification.

Principal Component Analysis (PCA) is a statistical technique used to simplify complex datasets by reducing their dimensionality while preserving as much variance as possible. It achieves this by transforming the original variables into a new set of uncorrelated variables called principal components. These principal components are ordered in such a way that the first few retain most of the variation present in the original dataset. The primary goal of PCA is to identify patterns in data and express the data in such a way that their similarities and differences are highlighted.

First, it helps in reducing the number of variables, making it easier to visualize and interpret the data, especially when dealing with high-dimensional datasets. By focusing on the principal components that capture the most variance, PCA can help in identifying the underlying structure of the data. Additionally, it aids in noise reduction by filtering out the less significant components that may represent noise rather than meaningful variation. This feature extraction process can improve the performance of algorithms by reducing overfitting and making the model more robust to new data.

FIG. 13 illustrates the concept of Principal Component Analysis (PCA), where the original data points are plotted in a two-dimensional space defined by axes x1 and x2, while the new axes, u1 and u2, represent the principal components derived from PCA. The importance of these new axes in the transformed space lies in their ability to capture the maximum variance in the data with fewer dimensions. By reorienting the data along these principal components, PCA reduces the complexity of the dataset while retaining the most critical information. This transformation simplifies analysis by highlighting the directions where the data varies the most, making it easier to identify patterns, trends, and relationships that might be obscured in the original space. These new axes optimize the data's representation, leading to more efficient and accurate downstream tasks such as classification or validation.

Principal Components (u1 and u2): These are new axes in the transformed space. The first principal component (u1) captures the direction of maximum variance in the data, which means it accounts for the largest amount of variability among the data points. The second principal component (u2) is orthogonal to the first and captures the next highest variance.

Data Transformation: The original data points, represented in the x1 and x2 space, are projected onto the new principal component axes. This transformation helps in reducing the dimensionality of the data, as it allows the data to be described with fewer dimensions while retaining most of the original variability.

FIG. 14 depicts that PCA is applied onto the 239 bands of hyperspectral data to reduce them to 16 highly contributing feature vectors to train the QML algorithm. PCA has been applied onto the smoothened data obtained from median filter, the data has been reduced from 239 bands to 16 featured vectors. These PCA reduced components retain most of the variation present in the original dataset.

When PCA is applied to a 239-band hyperspectral data point, it transforms the data into a new coordinate system defined by the principal components, which are ranked based on the amount of variance they capture from the original data. For example, if we consider the 5th principal component in this transformed space, its value represents the contribution of this specific component to the overall variance in the data for that pixel. In other words, it reflects how much of the original data's information, along this 5th most significant direction, is retained after the dimensionality reduction. The exact value of this component in a specific example would depend on the original spectral data of the pixel and how it projects onto this 5th principal axis. These values are crucial as they help in determine the importance of the components in accurately representing the data for validation using QSVM.

The original data is condensed into highly contributing feature vectors, optimizing the data for training and prediction using QML.

FIG. 15 depicts the Support Vector Machine (SVM) drawing a decision boundary to classify data points into two categories. In contrast, a Quantum Support Vector Machine (QSVM) operates on similar principles but leverages quantum computing to enhance classification and validation tasks, particularly for complex, high-dimensional data. QSVM, a key component of Quantum Machine Learning (QML), uses quantum feature maps to represent data in a higher-dimensional space, allowing for more accurate and efficient classification. In our case, QSVM significantly improves the validation process of auto-labeling hyperspectral data, ensuring the labels are assigned with greater precision, thereby enhancing the reliability of the overall classification.

Quantum Support Vector Machine (QSVM) is an adaptation of the classical Support Vector Machine (SVM) algorithm, utilizing principles of quantum computing to enhance data processing capabilities. In classical SVM, the goal is to find the optimal hyperplane that separates data points of different classes with the maximum margin. This involves solving optimization problems and is particularly useful for classification and regression tasks.

QSVM extends this concept by leveraging quantum algorithms and quantum-enhanced kernels to process data in a higher-dimensional space, which can potentially lead to more accurate and efficient solutions. QSVM is particularly useful in scenarios where traditional SVMs face limitations due to high-dimensional data or complex patterns that are difficult to separate using classical methods. Quantum computing's ability to process and store information in quantum bits (qubits) allows QSVM to explore a vastly larger computational space, enabling the discovery of patterns that might be infeasible to detect with classical SVMs. This can result in better generalization and performance, especially in domains where complex, high-dimensional data is common.

It is trained with the training data to achieve a classification score of 0.95 or higher, higher the score, better the QML algorithm performs in validation of the data. If this threshold is not met, additional data of target object are retrieved, and the process is repeated to refine the QML algorithm. One target reference data point is selected to generate samples necessary for validation, playing a critical role in subsequent classification steps.

The reference data point, along with the overall data of the target area, is inputted into the statistical techniques to identify and group similar data points. A threshold limit is set for these statistical techniques output, ensuring that only data points exceeding this similarity threshold are selected for validation.

For example, in one embodiment, statistical techniques are used for data analysis, clustering and classification. These techniques are a collection of methods and tools used in data analysis to extract meaningful insights from data, identify patterns, and make informed decisions. These techniques are fundamental to the field of statistics and are applied across a wide range of disciplines. They encompass a variety of approaches, from descriptive statistics, which summarize and describe the main features of a dataset, to inferential statistics, which draw conclusions and make predictions based on data samples.

One of the primary goals of statistical techniques is to establish a distance like measure to the underlying structure of data. This can involve estimating unknown parameters, such as the mean or variance of a population, or testing hypotheses about relationships between variables. Statistical techniques also include methods for classification and clustering.

For example, in one embodiment, statistical techniques like Maximum Likelihood Estimator (MLE) or Jeffries Matusita-Spectral Angle Mapper (JM-SAM) can be used to generate and group the data points which are similar and generate datasets only when the data points exceed the similarity threshold.

JMSAM, or Jeffries Matusita-Spectral Angle Mapper, is a hybrid classification and similarity measurement technique commonly used in remote sensing and hyperspectral image analysis. This method combines two distinct approaches: the Jeffries-Matusita (JM) distance and the Spectral Angle Mapper (SAM). The JM distance is a statistical measure used to quantify the separability between different classes or clusters, assessing how well they can be distinguished based on their probability distributions. The SAM, on the other hand, calculates the angle between spectral vectors, providing a measure of spectral similarity that is invariant to brightness.

By integrating these two approaches, JMSAM can leverage the strengths of both: the JM distance's ability to distinguish classes based on statistical properties and SAM's effectiveness in comparing spectral features. This method provides a robust tool for identifying subtle differences in spectral data, making it valuable for environmental monitoring, resource exploration, and agricultural analysis.

FIG. 16 depicts another statistical method of Maximum Likelihood Estimation (MLE) is a widely used technique for estimating the parameters of a probability distribution or statistical model. The fundamental idea behind MLE is to find the parameter values that maximize the likelihood function, which represents the probability of observing the given data under various parameter configurations. By maximizing this function, MLE identifies the most likely parameters that could have produced the observed data.

MLE is particularly useful in a variety of areas due to its generality and efficiency. One of the key strengths of MLE is its asymptotic properties; as the sample size increases, MLE estimators converge to the true parameter values and exhibit minimal variance, making them reliable and robust. In practical terms, MLE is used in model fitting, where it helps in estimating the parameters of models ranging from simple linear regressions to complex neural networks. Its role in hypothesis testing and confidence interval estimation further underscores its importance in statistical inference and decision-making processes.

In FIG. 16, θ represents the total data distribution and θ*hat represents the maximum likelihood between the data points.

For example, in one embodiment, a threshold is set for KLD, so the similar data points can be chosen which are within the threshold, to be further validated by QSVM.

KLD is a measure of how one probability distribution diverges from a second, expected probability distribution. It quantifies the difference between two probability distributions over the same variable.

KLD can be used to compare two probability distributions. It quantifies how much one probability distribution (the estimated distribution) diverges from a second, reference distribution (the true distribution or a distribution representing other data points). Essentially, KLD indicates the amount of information lost when the estimated distribution is used to approximate the true distribution, with a value of zero indicating perfect similarity. The key insight here is that KLD provides a measure of similarity: the smaller the KLD, the more similar the two distributions are. A threshold can be set from zero as the starting point to a desired number, so only those points, lying with in threshold limit can be chosen for further validation by QSVM.

When using KLD as a measure of similarity between data points or distributions, a threshold can be established to determine whether two data points are considered similar. Typically, values near zero indicate high similarity, as they suggest that the distributions are nearly identical.

If the KLD between two distributions is small (close to zero), it suggests that the estimated distribution is a good approximation of the true distribution. Conversely, larger KLD values indicate greater dissimilarity. In practice, we try to set a threshold to this as it can be used to identify outliers or anomalies in data, where higher divergence values might flag data points that significantly differ from the expected distribution.

KLD serves as a powerful tool for assessing the similarity between probability distributions. By setting an appropriate threshold, it can effectively distinguish between similar and dissimilar data points, providing valuable insights in various applications ranging from anomaly detection to model validation.

FIG. 17 illustrates the ZFeatureMap circuit, which is integral to the QSVM for processing the PCA components derived from the hyperspectral data. In this circuit, 16 qubits are used, each corresponding to one of the 16 feature vectors obtained after applying PCA. These feature vectors, represented as x[1], x[2], . . . , x[16], are encoded into the qubits through the ZFeatureMap, effectively mapping the classical data into a quantum state that the QSVM can process. Once the feature vectors are embedded into the qubits, the QSVM is trained on this quantum representation of the data. After training, the QSVM is used to validate new data, enabling accurate validation and labeling of the hyperspectral data based on the trained model. This process leverages the quantum nature of the QSVM to handle complex, high-dimensional data more efficiently than classical methods, ultimately yielding the required classification results.

Finally, the filtered and thresholded data is fed into the trained QML algorithm, which has achieved a classification score of 0.95 or above, for final validation.

The classification score is a measure of the model's ability to accurately predict the labels of the training data, providing an indication of how well the model has learned the underlying patterns in the data. This score is typically expressed as a percentage, providing a straightforward and intuitive measure of the model's performance. A high accuracy score, close to 100% (or 1.0), indicates that the model is highly effective at correctly classifying the test samples, suggesting that it has learned well from the training data.

On the other hand, a lower score may indicate that the model has not been trained effectively or that the data complexity exceeds the model's capacity to generalize. By calculating the accuracy based on the model's predictions on test data, it offers a clear measure of the model's ability to generalize from training to unseen data, which is a key indicator of the model's overall quality and usefulness.

This step auto-labels the previously unlabeled data accurately, leveraging the high classification capabilities of QML. This innovative hybrid Quantum-Classical solution significantly enhances the accuracy and efficiency of data analysis. By integrating classical preprocessing with quantum classification, the system can handle complex spectral signatures and reduce the need for extensive training data. The invention is particularly beneficial for remote sensing applications, including environmental monitoring, agricultural assessment, and urban planning, where accurate classification of land cover and materials is crucial.

FIG. 18 presents the original input map of the region under consideration alongside the resultant map generated using the specified product/software/algorithm. In the resultant map, white spots represent the labeled data for each pixel, while black spots indicate redundant data, which refers to information other than the target object. This demonstrates the effectiveness of the algorithm in autonomously labeling the target object on the map using only the target area as input, achieving precise data classification with minimal input. Additionally, the X-axis represents the pixel columns, while the Y-axis represents the pixel rows.

This product/software/algorithm outlines a robust and advanced method for data classification, combining state-of-the-art quantum and classical computing techniques to achieve superior results in data analysis.

What is claimed is:

1. A method for auto-labeling data using Quantum Machine Learning (QML), comprising:
Acquiring data files, said data comprising information corresponding to the target object (class to be identified);
Converting the data file format to desired usable format for further processing;
Extracting a specific area of interest from the usable file format to obtain reference data points for a target object;
Smoothening the extracted data using a Median Filter to reduce noise;
Applying Principal Component Analysis (PCA) to reduce the dimensionality of the data, resulting in a set of feature vectors;
Dividing the reduced dataset randomly into training and testing subsets;
Training a QML algorithm using the training subset to classify spectral signatures;
Testing the QML algorithm with the testing subset to achieve a classification score, and refining until the classification score meets or exceeds a predetermined threshold;
Using the KLD to group similar data points based on the reference data point from the target area, and setting a threshold limit to select data points;
Validating the filtered data using the trained QML algorithm to accurately auto-label the previously unlabeled data.

2. The method of claim 1, wherein the target object is identified from reference dataset.

3. The method of claim 1, wherein the data obtained from usable file format comprises the target area.

4. The method of claim 1, wherein the Median Filter is used to reduce noise in data and applied PCA to reduce the data from higher complexity to highly contributing feature vectors.

5. The method of claim 1, further comprising the step of repeating the process with additional reference data points if the QML algorithm classification score does not meet the predetermined threshold.

6. The method of claim 1, wherein the reference data point is used to generate samples from statistical techniques required for validation.

7. The method of claim 1, wherein the KLD groups similar data points based on their spectral signatures from the target area, and the threshold limit ensures only highly similar data points are selected for validation.

8. The method of claim 1, wherein the QML algorithm validates the data obtained from the statistical techniques and auto-labels the previously unlabeled data.

9. A system for auto-labeling data, comprising:
A data acquisition module for retrieving data;
A conversion module for transforming from original file format data to usable file format;
An extraction module for selecting a specific area of interest from the usable file format to obtain reference data points;
A preprocessing module for smoothening the data using a Median Filter and applying PCA to reduce dimensionality;
A training module for training the QML with a subset of the PCA reduced data;
A testing module for testing the QML with a subset of the PCA reduced data;
A validation module for using the statistical techniques to group similar data points and setting a threshold limit for selecting data points from one target reference data point as input along with target area;
A classification module for validating the filtered data using QML to accurately label the data.

10. The system of claim 9, wherein the reference data points are obtained using from reference dataset.

11. The system of claim 9, wherein Median Filter is applied to the extracted area of interest to reduce noise and applied PCA to reduce the dimensionality of the data.

12. The system of claim 9, wherein the training module refines the QML algorithm until it achieves a classification score of 0.95 or higher.

13. The system of claim 9, wherein the validation module groups similar data points based on their spectral signatures and ensures only highly similar data points are selected for validation using the threshold limit.

14. The system of claim 9, wherein samples are validated using QML to auto-label the data.
